(19) United States
(12) Patent Application Publication
(10) Pub. No.: US 2024/0239378 A1
(43) Pub. Date: Jul. 18, 2024

(54) Systems and Methods for Handling Traffic Signs

(71) Applicant: FORD GLOBAL TECHNOLOGIES, LLC, Dearborn, MI (US)

(72) Inventors: Neal SEEGMILLER, Pittsburgh, PA (US); Patrick BARONE, San Francisco, CA (US); Greydon FOIL, Pittsburgh, PA (US); Joshua JAEKEL, Detroit, MI (US); Timothy James DOUGLAS, Pittsburgh, PA (US); Timothy CUMMINGS, Cranberry Township, PA (US)

(73) Assignee: FORD GLOBAL TECHNOLOGIES, LLC, Dearborn, MI (US)

(21) Appl. No.: 18/093,614

(22) Filed: Jan. 5, 2023

(51) Int. Cl. B60W 60/00; G01C 21/00

(52) U.S. Cl. CPC B60W 60/0027; G01C 21/3807; B60W 2555/60; B60W 2556/40; B60W 2556/45

(57) ABSTRACT

Disclosed herein are system, method, and computer program product embodiments for handling traffic signs. For example, the method includes receiving sensor data from a sensor of a vehicle and identifying a traffic sign within a field of view of the vehicle based on the sensor data. The method also includes assigning a probable class to the identified sign based on a determination that the identified sign is not mapped in a priori map and a determination that a probability of existence of the sign is greater than a threshold and modifying a behavior of the vehicle based on the assigned probable class.

### BACKGROUND

Autonomous vehicles (AVs) rely on maps to navigate in a real-world environment during operation. A map may be a set of digital files including data identifying physical details of a geographic area such as roads, lanes within roads, traffic signals and signs, and road surface markings. The map may be generated using images of the surroundings captured by vehicles equipped with sensors such as light detection and ranging system (LIDAR), cameras, radar, and the like. An AV may receive the map before operation. An AV may use the map to augment the information that the AV's on-board perception system (e.g., cameras, LIDAR system) perceives.

In general, the contents of the received map are static until the AVs download/receive an updated map. Map changes can occur due to new road constructions, repainting of roads, and/or construction projects that may result in temporary lane changes and/or detours. Maps can change several times per day. For example, a new traffic sign (e.g., a stop sign) may be installed and the changes are not reflected on the map. Thus, systems and methods are needed to incrementally update the map to reflect any changes to traffic signs.

### SUMMARY

According to some aspects of this disclosure, a method includes receiving sensor data from a sensor of a vehicle and identifying a traffic sign within a field of view of the vehicle based on the sensor data. The method also includes assigning a probable class to the identified sign based on a determination that the identified sign is not mapped in a priori map and a determination that the probability of the existence of the sign is greater than a threshold and modifying behavior of the vehicle based on the assigned probable class.

According to some aspects of this disclosure, a system includes memory and at least one processor coupled to the memory. The at least one processor is configured to receive sensor data from a sensor of a vehicle, identify a traffic sign within a field of view of the vehicle based on the sensor data, and assign a probable class to the identified sign based on a determination that the identified sign is not mapped in a priori map and a determination that a probability of the existence of the sign is greater than a threshold. The at least one processor is further configured to modify the behavior of the vehicle based on the assigned probable class.

### BRIEF DESCRIPTION OF THE DRAWINGS

The accompanying drawings are incorporated herein and form a part of the specification.

FIG. 1 illustrates an exemplary autonomous vehicle system, in accordance with aspects of the disclosure.

FIG. 2 illustrates an exemplary architecture for a vehicle, in accordance with aspects of the disclosure.

FIG. 3 is an example control flow of a system for handling traffic signs, in accordance with aspects of the disclosure.

FIG. 4A is a schematic that illustrates a road intersection with an unmapped traffic sign, in accordance with aspects of the disclosure.

FIG. 4B is a schematic that illustrates a road with an unmapped traffic sign, in accordance with aspects of the disclosure.

FIG. 5 is a schematic that illustrates a lane conflict type override, in accordance with aspects of the disclosure.

FIG. 6 is a schematic that illustrates a stop line associated with an unmapped stop sign, in accordance with aspects of the disclosure.

FIG. 7 is a schematic that illustrates a field of view of a vehicle, in accordance with aspects of the disclosure.

FIG. 8 is a flowchart for a method for updating tracks, in accordance with aspects of the disclosure.

FIG. 9 is a flowchart for a method for handling a detected traffic sign, in accordance with aspects of the disclosure.

FIG. 10A and FIG. 10B are schematics that illustrate an image space for determining a detectability of a sign, in accordance with aspects of the disclosure.

FIG. 11 is a schematic that illustrates relevant tracks in evaluating a total occlusion area, in accordance with aspects of the disclosure.

FIG. 12 is a flowchart for a method for updating a probability of a mapped sign, in accordance with aspects of the disclosure.

FIG. 13 is a flowchart for a method for handling traffic signs, in accordance with aspects of the disclosure.

FIG. 14 is an example computer system useful for implementing various aspects of the disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for handling unmapped traffic signs.

An autonomous vehicle (AV) may rely on a map (e.g., a base map, an a priori map, a priori high definition (HD) map, etc.) of an operating area. The map may refer to a pre-generated map that is downloaded onto the AV and is used by the AV to help navigate its surroundings. The map may include information associated with the operating area. For example, the map may specify the geometry of a drivable area and lane markings, lane marking types, a direction of a lane, a speed limit associated with the lane, and traffic controls including traffic signs and traffic signals. The traffic signs may include a stop sign or a yield sign. The map reduces the burden on the autonomy software of the AV to construct an accurate model of its environment. However, sometimes the map is inaccurate. For example, if a new stop sign or a new yield sign is placed alongside the road that was not present when data was collected for the map, it may be omitted from the map. If the vehicle does not detect and appropriately react to the new sign, it may result in a traffic violation, the vehicle potentially violating the right of way of another road user, and/or the like. According to some aspects of this disclosure, a test specialist may take over when an unmapped traffic sign is encountered but this is not a viable solution for a fully autonomous vehicle with no test specialist inside.

A trajectory generator of the AV may receive an indication of an unmapped traffic sign and plan to stop at a location of the unmapped traffic sign. According to some aspects of this disclosure, the indication may be received from a perception system of the AV. However, this technique suffers from several disadvantages. Other components of the AV (i.e., besides the trajectory generator) are unaware of the traffic sign. For example, a prediction component of the AV may not predict the other actors will stop for the unmapped sign as the prediction component is not aware of the unmapped sign. In addition, software code written for autonomously navigating intersections no longer has a single source of truth. The code may be updated in multiple places to check both the map and unmapped traffic sign messages received from the perception system-making the code more complicated to test and maintain.

According to some aspects of this disclosure, unmapped traffic signs are handled through dynamic map updates. This provides the advantage that all components of the AV that rely on the map receive the same and accurate updates in a timely manner (e.g., in real-time or near real-time). In addition, the software code that relies on the map can remain unchanged.

According to some aspects of this disclosure, the approaches of the current disclosure detect unmapped traffic signs (e.g., stop or yield signs) through the perception system and dynamically update the a priori map to include the detected traffic signs. According to some aspects of this disclosure, the perception system of the vehicle detects and tracks signs. Tracked signs are compared against signs already in the a priori map to determine if they are unmapped signs. Tracked signs are also compared against a record of persistent false positive detections to determine if the detection is a known false positive. A map deviation task generates and publishes a map update message when the sign is unmapped and is not a known false detection. According to some aspects of this disclosure, the map update message is processed by a map update framework that disseminates the update to the map to all dependent tasks, as will be described further below.

According to some aspects of this disclosure, a remote guidance operator reviews the unmapped sign detection and confirms it, and issues guidance enabling the AV to proceed past the unmapped sign when the AV determines it is appropriate to do so. For example, a remote human operator may provide remote guidance to the AV in real-time or near real-time. An annotation is logged for the unmapped sign that prompts a mapping analyst to review the unmapped traffic sign offline and update the a priori map if necessary. The trajectory generator task uses the updated map to correctly navigate intersections with unmapped signs like it would navigate intersections with mapped signs. Remote guidance is required to proceed past unmapped stop signs. Before describing the system and method for handling unmapped traffic signs in more detail, it is useful to provide some background information about AV systems.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones, and/or the like. An “autonomous vehicle” (or “AV”) is a vehicle having a processor, programming instructions, and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

Notably, the present solution is described herein in the context of an autonomous vehicle. However, the present solution is not limited to autonomous vehicle applications. The present solution may be used in other applications such as robotic applications, radar system applications, metric applications, and/or system performance applications.

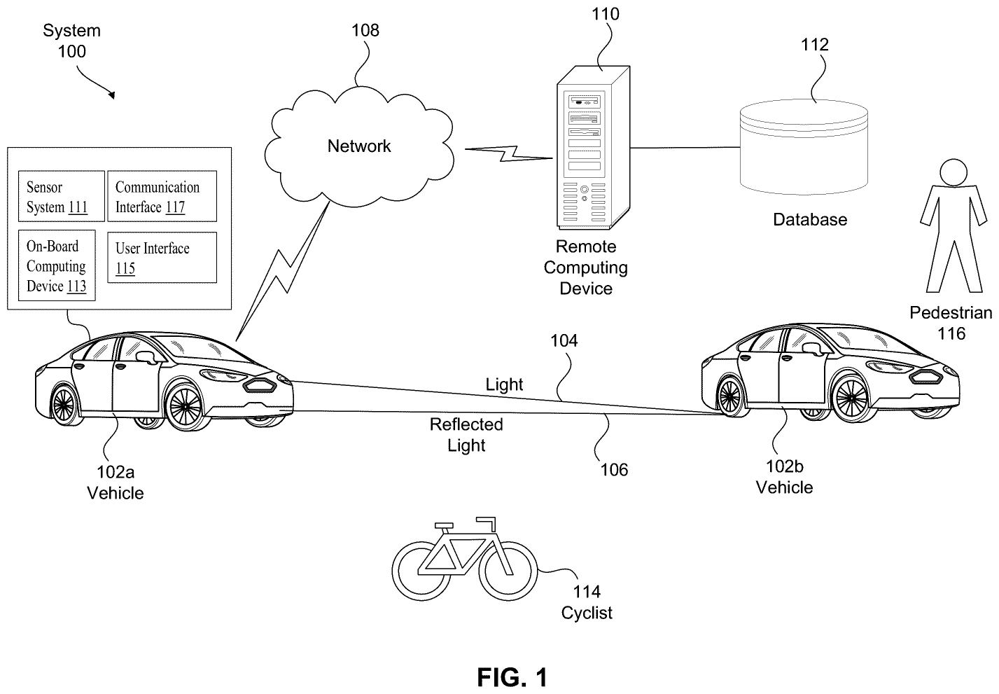

FIG. 1 illustrates an exemplary AV system 100, in accordance with aspects of the disclosure. System 100 comprises a vehicle 102a which is traveling along a road in a semi-autonomous or autonomous manner. Vehicle 102a is also referred to herein as AV 102a. AV 102a can include, but is not limited to, a land vehicle (as shown in FIG. 1), an aircraft, or a watercraft.

AV 102a is generally configured to detect objects 102b, 114, 116 in proximity thereto. The objects can include, but are not limited to, a vehicle 102b, cyclist 114 (such as a rider of a bicycle, electric scooter, motorcycle, or the like) and/or a pedestrian 116.

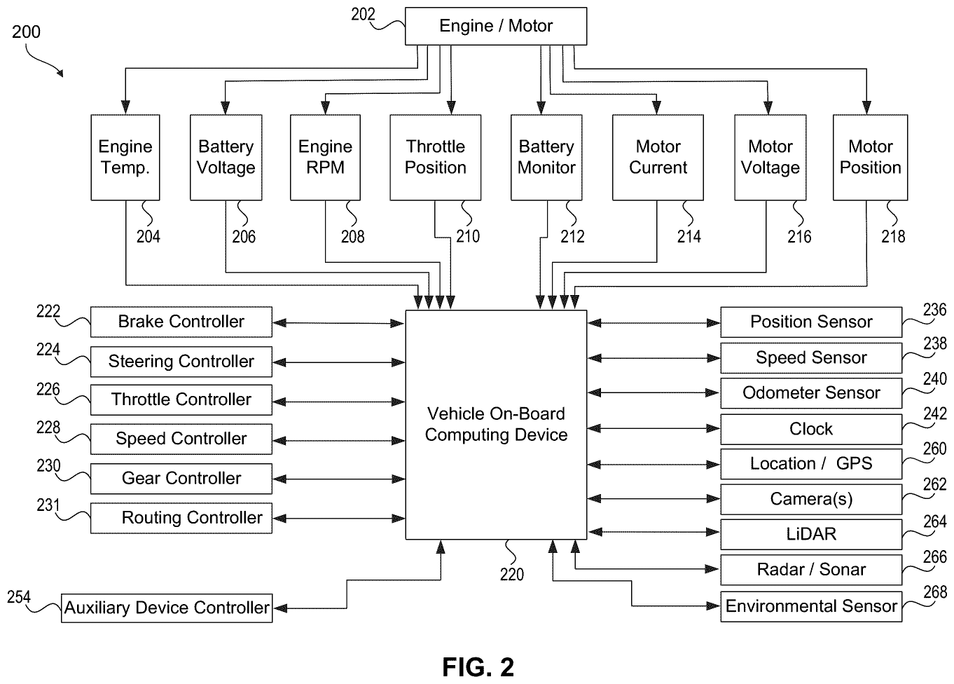

As illustrated in FIG. 1, the AV 102a may include a sensor system 111, an on-board computing device 113, a communications interface 117, and a user interface 115. Autonomous vehicle 101 may further include certain components (as illustrated, for example, in FIG. 2) included in vehicles, which may be controlled by the on-board computing device 113 using a variety of communication signals and/or commands, such as, for example, acceleration signals or commands, deceleration signals or commands, steering signals or commands, braking signals or commands, etc.

The sensor system 111 may include one or more sensors that are coupled to and/or are included within the AV 102a, as illustrated in FIG. 2. For example, such sensors may include, without limitation, a light detection and ranging (LIDAR) system, a radio detection and ranging (RADAR) system, a laser detection and ranging (LADAR) system, a sound navigation and ranging (SONAR) system, one or more cameras (e.g., visible spectrum cameras, infrared cameras, etc.), temperature sensors, position sensors (e.g., a global positioning system (GPS), etc.), location sensors, fuel sensors, motion sensors (e.g., inertial measurement units (IMU), etc.), humidity sensors, occupancy sensors, or the like. The sensor data can include information that describes the location of objects within the surrounding environment of the AV 102a, information about the environment itself, information about the motion of the AV 102a, information about a route of the vehicle, or the like. As AV 102a travels over a surface, at least some of the sensors may collect data pertaining to the surface.

As will be described in greater detail, AV 102a may be configured with a LIDAR system, e.g., LIDAR system 264 of FIG. 2. The LIDAR system may be configured to transmit a light pulse 104 to detect objects located within a distance or range of distances of AV 102a. Light pulse 104 may be incident on one or more objects (e.g., AV 102b) and be reflected back to the LIDAR system. Reflected light pulse 106 incident on the LIDAR system may be processed to determine a distance of that object to AV 102a. According to some aspects of this disclosure, the reflected light pulse may be detected using a photodetector or array of photodetectors positioned and configured to receive the light reflected back into the LIDAR system. LIDAR information, such as detected object data, is communicated from the LIDAR system to an on-board computing device, e.g., on-board computing device 220 of FIG. 2. The AV 102a may also communicate LIDAR data to a remote computing device 110 (e.g., cloud processing system) over a communications network 108. Remote computing device 110 may be configured with one or more servers to process one or more processes of the technology described herein. Remote computing device 110 may also be configured to communicate data/instructions to/from AV 102a over network 108, to/from a server(s) and/or database(s) 112.

It should be noted that the LIDAR systems for collecting data pertaining to the surface may be included in systems other than the AV 102a such as, without limitation, other vehicles (autonomous or driven), robots, satellites, etc.

Network 108 may include one or more wired or wireless networks. For example, the network 108 may include a cellular network (e.g., a long-term evolution (LTE) network, a code division multiple access (CDMA) network, a 3G network, a 4G network, a 5G network, another type of next-generation network, etc.). The network may also include a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

AV 102a may retrieve, receive, display, and edit information generated from a local application or delivered via network 108 from database 112. Database 112 may be configured to store and supply raw data, indexed data, structured data, map data, program instructions, or other configurations as are known.

The communications interface 117 may be configured to allow communication between AV 102a and external systems, for example, external devices, sensors, other vehicles, servers, data stores, databases, etc. The communications interface 117 may utilize any now or hereafter-known protocols, protection schemes, encodings, formats, packaging, etc. such as, without limitation, Wi-Fi, an infrared link, Bluetooth, etc. The user interface 115 may be part of peripheral devices implemented within the AV 102a including, for example, a keyboard, a touchscreen display device, a microphone, and a speaker, etc.

FIG. 2 illustrates an exemplary system architecture 200 for a vehicle, in accordance with aspects of the disclosure. Vehicles 102a and/or 102b of FIG. 1 can have the same or similar system architecture as that shown in FIG. 2. Thus, the following discussion of system architecture 200 is sufficient for understanding vehicle(s) 102a, 102b of FIG. 1. However, other types of vehicles are considered within the scope of the technology described herein and may contain more or fewer elements as described in association with FIG. 2. As a non-limiting example, an airborne vehicle may exclude brake or gear controllers, but may include an altitude sensor. In another non-limiting example, a water-based vehicle may include a depth sensor. One skilled in the art will appreciate that other propulsion systems, sensors, and controllers may be included based on a type of vehicle, as is known.

As shown in FIG. 2, system architecture 200 includes an engine or motor 202 and various sensors 204-218 for measuring various parameters of the vehicle. In gas-powered or hybrid vehicles having a fuel-powered engine, the sensors may include, for example, an engine temperature sensor 204, a battery voltage sensor 206, an engine Rotations Per Minute (“RPM”) sensor 208, and a throttle position sensor 210. If the vehicle is an electric or hybrid vehicle, then the vehicle may have an electric motor, and accordingly includes sensors such as a battery monitoring system 212 (to measure current, voltage and/or temperature of the battery), motor current 214, and voltage 216 sensors, and motor position sensors 218 such as resolvers and encoders.

Operational parameter sensors that are common to both types of vehicles include, for example: a position sensor 236 such as an accelerometer, gyroscope and/or inertial measurement unit; a speed sensor 238; and an odometer sensor 240. The vehicle also may have a clock 242 that the system uses to determine vehicle time during operation. The clock 242 may be encoded into the vehicle on-board computing device, it may be a separate device, or multiple clocks may be available.

The vehicle also includes various sensors that operate to gather information about the environment in which the vehicle is traveling. These sensors may include, for example: a location sensor 260 (e.g., a Global Positioning System (“GPS”) device); object detection sensors such as one or more cameras 262; a LIDAR system 264; and/or a radar and/or a sonar system 266. The sensors also may include environmental sensors 268 such as a precipitation sensor and/or ambient temperature sensor. The object detection sensors may enable the vehicle to detect objects that are within a given distance range of the vehicle 200 in any direction, while the environmental sensors collect data about environmental conditions within the vehicle's area of travel.

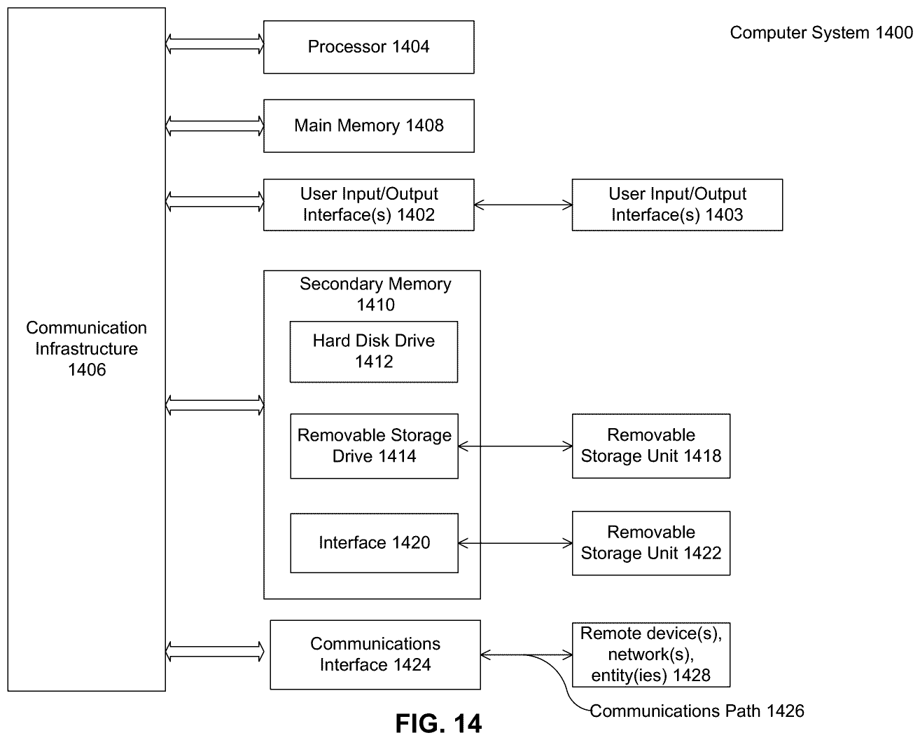

During operations, information is communicated from the sensors to a vehicle on-board computing device 220. The on-board computing device 220 may be implemented using the computer system of FIG. 14. The vehicle on-board computing device 220 analyzes the data captured by the sensors and optionally controls operations of the vehicle based on results of the analysis. For example, the vehicle on-board computing device 220 may control: braking via a brake controller 222; direction via a steering controller 224; speed and acceleration via a throttle controller 226 (in a gas-powered vehicle) or a motor speed controller 228 (such as a current level controller in an electric vehicle); a differential gear controller 230 (in vehicles with transmissions); and/or other controllers. Auxiliary device controller 254 may be configured to control one or more auxiliary devices, such as testing systems, auxiliary sensors, mobile devices transported by the vehicle, etc.

Geographic location information may be communicated from the location sensor 260 to the on-board computing device 220, which may then access a map of the environment that corresponds to the location information to determine known fixed features of the environment such as streets, buildings, stop signs and/or stop/go signals. Captured images from the cameras 262 and/or object detection information captured from sensors such as LIDAR system 264 is communicated from those sensors) to the on-board computing device 220. The object detection information and/or captured images are processed by the on-board computing device 220 to detect objects in proximity to the vehicle 200. Any known or to be known technique for making an object detection based on sensor data and/or captured images can be used in the examples disclosed in this document.

LIDAR information is communicated from LIDAR system 264 to the on-board computing device 220. Additionally, captured images are communicated from the camera(s) 262 to the vehicle on-board computing device 220. The LIDAR information and/or captured images are processed by the vehicle on-board computing device 220 to detect objects in proximity to the vehicle 200. The manner in which the object detections are made by the vehicle on-board computing device 220 includes such capabilities detailed in this disclosure.

The on-board computing device 220 may include and/or may be in communication with a routing controller 231 that generates a navigation route from a start position to a destination position for an autonomous vehicle. The routing controller 231 may access a map data store to identify possible routes and road segments that a vehicle can travel on to get from the start position to the destination position. The routing controller 231 may score the possible routes and may identify a preferred route to reach the destination. For example, the routing controller 231 may generate a navigation route that minimizes Euclidean distance traveled or other cost functions during the route, and may further access the traffic information and/or estimates that can affect an amount of time it will take to travel on a particular route. Depending on the implementation, the routing controller 231 may generate one or more routes using various routing methods, such as Dijkstra's algorithm, Bellman-Ford algorithm, or other algorithms. The routing controller 231 may also use the traffic information to generate a navigation route that reflects expected conditions of the route (e.g., current day of the week, current time of day, etc.), such that a route generated for travel during rush hour may differ from a route generated for travel late at night. The routing controller 231 may also generate more than one navigation route to a destination and send more than one of these navigation routes to a user for selection by the user from among various possible routes.

According to some aspects of this disclosure, the on-board computing device 220 may determine perception information of the surrounding environment of the AV 102a. Based on the sensor data provided by one or more sensors and location information that is obtained, the on-board computing device 220 may determine perception information of the surrounding environment of the AV 102a. The perception information may represent what an ordinary driver would perceive in the surrounding environment of a vehicle. The perception data may include information relating to one or more objects in the environment of the AV 102a. For example, the on-board computing device 220 may process sensor data (e.g., LIDAR or RADAR data, camera images, etc.) in order to identify objects and/or features in the environment of AV 102a. The objects may include traffic signals, roadway boundaries, other vehicles, pedestrians, and/or obstacles, etc. The on-board computing device 220 may use any now or hereafter-known object recognition algorithms, video tracking algorithms, and computer vision algorithms (e.g., track objects frame-to-frame iteratively over a number of time periods) to determine the perception.

According to some aspects of this disclosure, the on-board computing device 220 may also determine, for one or more identified objects in the environment, the current state of the object. The state information may include, without limitation, for each object: current location; current speed and/or acceleration, current heading; current pose; current shape, size, or footprint; type (e.g., vehicle vs. pedestrian vs. bicycle vs. static object or obstacle); and/or other state information.

The on-board computing device 220 may perform one or more prediction and/or forecasting operations. For example, the on-board computing device 220 may predict future locations, trajectories, and/or actions of one or more objects. For example, the on-board computing device 220 may predict the future locations, trajectories, and/or actions of the objects based at least in part on perception information (e.g., the state data for each object comprising an estimated shape and pose determined as discussed below), location information, sensor data, and/or any other data that describes the past and/or current state of the objects, the AV 102a, the surrounding environment, and/or their relationship(s). For example, if an object is a vehicle and the current driving environment includes an intersection, the on-board computing device 220 may predict whether the object will likely move straight forward or make a turn. If the perception data indicates that the intersection has no traffic light, the on-board computing device 220 may also predict whether the vehicle may have to fully stop prior to entering the intersection.

According to some aspects of this disclosure, the on-board computing device 220 may determine a motion plan for the autonomous vehicle. For example, the on-board computing device 220 may determine a motion plan for the autonomous vehicle based on the perception data and/or the prediction data. Specifically, given predictions about the future locations of proximate objects and other perception data, the on-board computing device 220 can determine a motion plan for the AV 102a that best navigates the autonomous vehicle relative to the objects at their predicted future locations.

According to some aspects of this disclosure, the on-board computing device 220 may receive predictions and make a decision regarding how to handle objects and/or actors in the environment of the AV 102a. For example, for a particular actor (e.g., a vehicle with a given speed, direction, turning angle, etc.), the on-board computing device 220 decides whether to overtake, yield, stop, and/or pass based on, for example, traffic conditions, map data, state of the autonomous vehicle, etc. Furthermore, the on-board computing device 220 also plans a path for the AV 102a to travel on a given route, as well as driving parameters (e.g., distance, speed, and/or turning angle). That is, for a given object, the on-board computing device 220 decides what to do with the object and determines how to do it. For example, for a given object, the on-board computing device 220 may decide to pass the object and may determine whether to pass on the left side or right side of the object (including motion parameters such as speed). The on-board computing device 220 may also assess the risk of a collision between a detected object and the AV 102a. If the risk exceeds an acceptable threshold, it may determine whether the collision can be avoided if the autonomous vehicle follows a defined vehicle trajectory and/or implements one or more dynamically generated emergency maneuvers is performed in a pre-defined time period (e.g., N milliseconds). If the collision can be avoided, then the on-board computing device 220 may execute one or more control instructions to perform a cautious maneuver (e.g., mildly slow down, accelerate, change lane, or swerve). In contrast, if the collision cannot be avoided, then the on-board computing device 220 may execute one or more control instructions for execution of an emergency maneuver (e.g., brake and/or change a direction of travel).

As discussed above, planning and control data regarding the movement of the autonomous vehicle is generated for execution. The on-board computing device 220 may, for example, control braking via a brake controller; direction via a steering controller; speed and acceleration via a throttle controller (in a gas-powered vehicle) or a motor speed controller (such as a current level controller in an electric vehicle); a differential gear controller (in vehicles with transmissions); and/or other controllers.

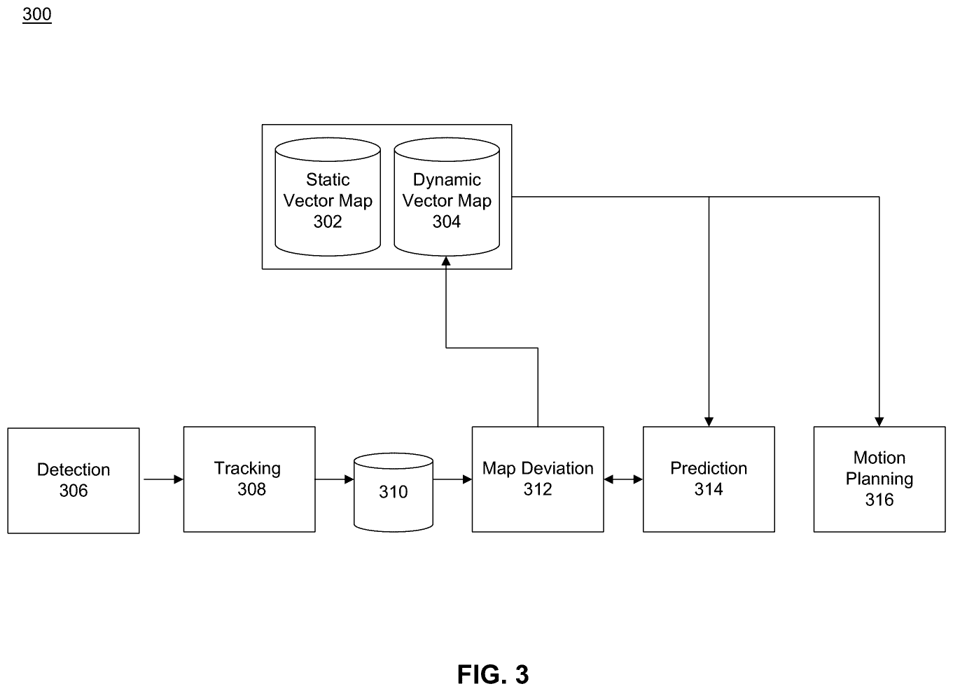

FIG. 3 is a control flow of a system 300 for handling traffic signs, in accordance with aspects of the disclosure. Certain components of the system 300 may be embodied in processor hardware and computer-readable programming instructions that are part of the AV's on-board computing system (e.g., on-board computing device 113 of FIG. 1).

According to some aspects of this disclosure, the control flow can begin by detecting an object using a detection task 306 (also referred to as perception system, task, or module). The detection task 306 may include hardware (sensors) and software (detection and tracking algorithms) that capture information about moving actors and other objects (e.g., road users, static obstacles, traffic signal state, and the like) that exist in the vehicle's immediate surroundings. Example sensors include cameras, LIDAR sensors, and radar sensors. Detection task 306 may detect one or more objects in the environment. For example, detection task 306 may detect traffic control objects including, but not limited to, signs and/or the like. According to some aspects of this disclosure, the detection task 306 may detect signs including, but not limited to, stop signs, yield signs, and/or the like. According to some aspects of this disclosure, signs are detected using the fusion of camera and LIDAR sensor inputs (e.g., LIDAR system 264 of FIG. 2).

According to some aspects of this disclosure, the detection task 306 may deliver data and information to a tracking task 308. The tracking task 308 produces messages about all tracked signs. The message may include a probability distribution over a type of the detected sign (e.g., stop, yield), a pose of the detected sign (position and orientation), a bounding geometry, a unique identifier, a timestamp of a first detection of the detected sign, and a probability of existence of the detected sign.

The probability of existence of the detected sign and the probability distribution over the type of the detected sign may be calculated with a Bayes filter. The Bayes filter aggregates noisy detections over time to provide stable probability values for whether the sign exists and the type of the sign. Map updates may be based on probability thresholds to avoid unnecessary stops for false positives. For example, a map update may be generated when the probability of existence of the detected sign exceeds a first threshold (e.g., 10%).

According to some aspects of this disclosure, sign detections may be associated with an existing set of tracked signs. The existing set of tracked signs provides information about the detected sign attributes over time. New tracks are created for detections that cannot be associated with any existing tracks. For example, tracked traffic signs (stop sign or yield sign) are compared against signs in the map in the tracking task 308. If the detected sign matches the type of the sign and is within a position and orientation tolerance of a mapped sign, the sign detection is determined to be already mapped. The probability that the sign is mapped can be calculated using a Bayes filter. The map update is not generated for mapped traffic signs because the mapped traffic signs are already accounted for in the map. Unmapped traffic signs may be stored in a database 310.

Tracked traffic signs may also be compared against a record of persistent false positive detections. The record of persistent false positive detections may be stored in the database 310. According to some aspects of this disclosure, the record of persistent false positive may be updated from a server and propagated to AVs. Persistent false positive sign detections may be recorded in the map along with actual signs. Examples of false positive detections may include, but are not limited to, a sign that contains an image of a stop sign, but isn't itself a stop sign (e.g., a sign that warns of a stop sign ahead) or an image of a sign on a building or other structure that isn't actually a traffic sign (e.g., an image on a billboard).

If the detected sign matches the type of sign and is within a position and orientation tolerance of a known false positive, the sign detection may be filtered out to avoid nuisance stops and calls to remote guidance. According to some aspects of this disclosure, the tolerance may be less than 1 meter, less than 0.5 meters, or any other predetermined distance between the known false positive and the detected sign. According to some aspects of this disclosure, only the first AV to encounter the false positive has to stop and establish a connection with remote guidance, as discussed further below. According to some aspects of this disclosure, subsequent encounters by the same AV or other AVs can filter out the false positive and proceed uninterrupted.

According to some aspects of this disclosure, if the sign detection is not determined to be already mapped or a known false positive, a map update may be generated by a map deviation task 312. The map update may include, but is not limited to, the type of sign (stop or yield). According to some aspects of this disclosure, an annotation may be logged for each unmapped sign detection. According to some aspects of this disclosure, mapping analysts may review these annotations off-board to determine if the map is to be updated. According to some aspects of this disclosure, if the unmapped stop/yield sign is a new permanently installed sign, it may be added to the map. According to some aspects of this disclosure, if the unmapped sign is only temporary (e.g., associated with construction) the map may be left unchanged. For example, during a construction project, a stop sign may be temporarily installed or removed depending on when road crews are working in a particular location.

According to some aspects of this disclosure, updates to the map generated by the map deviation task 312 may be represented in a vector map. The vector map may comprise information corresponding to a plurality of unmapped traffic signs. The vector maps may be stored in one or more cloud databases or may be stored locally on the AV. For example, the updates may be stored in a dynamic vector map 304. A static vector map 302 which contains a priori map information may have been downloaded and stored in the AV before the AV operation. The dynamic vector map 304 may store differences between the static vector map 302 and the updates and additions received from the map deviation task 312.

The map update is propagated to all clients of the map. Clients may refer to software and/or hardware components of the AV that utilize the updated map to operate the AV (e.g., a prediction task 314, a motion planning task 316). All clients of the map receive the exact same updates. According to some aspects of this disclosure, the updates may be performed via application programming interfaces (APIs). According to some aspects of this disclosure, map updates may be communicated to the prediction task 314 and/or to the motion planning task 316 via shared memory. The unchanged map is not copied into the dynamic vector map cache. The dynamic vector map 304 may be sent to all clients that rely on the map. In addition, the updates are received with minimal latency (e.g., in real-time or near real-time). According to some aspects of this disclosure, a map interface associated with the static vector map 302 and the dynamic vector map 304 provides functions to query for both mapped and unmapped signs for a given lane segment, and to query for updated conflict types in all lane conflicts as described further below. A lane segment may refer to a segment of a road where the AVs and other vehicles move in a single-file fashion in a single direction. Multiple lane segments may occupy the same physical space (e.g., in an intersection).

According to some aspects of this disclosure, a behavior of the AV may be modified or adjusted based on the detected traffic sign. The prediction task 314 may process data received from the map deviation task 312 and/or the dynamic vector map 304 and forecast actions of other actors that the detection task 306 detects.

The motion planning task 316 may receive data and information from the prediction task 314, the static vector map 302, and the dynamic vector map 304. According to some aspects of this disclosure, a trajectory generator of the motion planning task 316 may require the AV to complete a timed stop at stop signs before proceeding past them. The trajectory generator does not require the AV to stop for yield signs. However, the trajectory generator may slow the AV for yield signs.

According to some aspects of this disclosure, a remote guidance operator may be notified and asked to provide guidance when an update for an unmapped sign is received (e.g., received by the motion planning task 316). The remote guidance operator may determine whether the unmapped sign detection is valid. For example, the remote guidance operator may determine whether there is actually a new traffic signal not accounted for in the a priori map. If the remote guidance operator indicates that the detection is a false detection, it can be recorded to prevent future false detections as explained above.

The remote guidance operator may also indicate to the AV whether the AV may proceed past the unmapped sign after completing a timed stop and autonomously determining it is appropriate to proceed. That is, the remote guidance operator does not indicate when the AV should proceed through the intersection, as they may not have sufficient situational awareness. The trajectory generator determines when to proceed based on the updated map and its perception of the scene.

The trajectory generator navigates intersections with unmapped stop and yield signs using the updated map, much as it would navigate intersections with a priori mapped stop signs. The trajectory generator generates a constraint to stop at the inferred stop line for the unmapped stop sign until a timed stop is completed, the remote guidance operator issues guidance that the AV can proceed when it is appropriate to do so, and all other road users in lane conflicts with the right of way over the AV have cleared the intersection.

The modules described with respect to FIG. 3 may be implemented as instructions stored on a non-transitory computer-readable medium to be executed by one or more computing units such as a processor, a special purpose computer, an integrated circuit, integrated circuit cores, or a combination thereof. The non-transitory computer-readable medium may be implemented with any number of memory units/components, such as a volatile memory, a nonvolatile memory, an internal memory, an external memory, or a combination thereof. The non-transitory computer-readable medium may be integrated as a part of the system 300 or installed as a removable portion of the system 300.

As discussed previously herein, the AV may follow a process flow when an unmapped traffic sign is encountered. A set of constraints may be generated once the unmapped traffic sign is encountered. For example the AV may stop at the sign and awaits remote guidance. The AV may not proceed past unmapped stop signs until an indication is received from the remote guidance operator. The remote guidance operator may send a unique identifier associated with the unmapped sign indicating that the AV may proceed. This is to ensure appropriate operations in case more than one unmapped signs are visible simultaneously. According to some aspects of this disclosure, guidance from the remote guidance operator may be received before the AV reaches the stop sign or after the AV has been stopped for several seconds.

According to some aspects of this disclosure, the generation of a dynamic vector map 304 may include associating the unmapped stop sign with the map. Thus, the lane segments that the stop sign controls traffic on are determined from the position and orientation of the unmapped stop sign. Further, a determination is made to whether the stop sign gates entry into a lane segment (like a typical mapped stop sign) or whether it indicates a stop at some distance along the lane segment. A sign may gate entry into a lane segment even if it does not physically coincide with the exact lane segment break (i.e., endpoint). In addition, generation of a dynamic vector map 304 may include determining the conflict types for lane segments associated with the unmapped traffic sign as it is described further below. The map deviation task 312 may handle multiple unmapped stop signs associated with the same lane segment at different distances along the lane segment.

Stop signs are typically associated with lane segments in intersections and control entry into them in the map. According to some aspects of this disclosure, lane segments associated with each unmapped sign are determined. A nearest lane segment within a position and orientation tolerance is found. The orientation tolerance ensures signs are only associated with lanes they “face,” i.e., in which traffic has visibility of the sign face. Same direction neighbors of that nearest lane segment are found. The sign with the nearest segment (and neighbors), or with the successors of these segments (lane segments that come after) if the sign is sufficiently near the successors, and the successors are in an intersection are associated.

According to some aspects of this disclosure, the AV may stop at a stop line associated with the traffic line. The stop line may indicate where the AV may complete a timed stop. According to some aspects of this disclosure, a stop line may be painted. The detected painted line is considered the stop line and the AV stops at the painted line. According to some aspects of this disclosure, a painted line is not detected. Thus, a virtual stop line (or inferred stop line) may be associated with the detected traffic sign. The virtual stop line is placed at a physical location of the sign. According to some aspects of this disclosure, the virtual line may cross the lanes associated with the detected sign orthogonally.

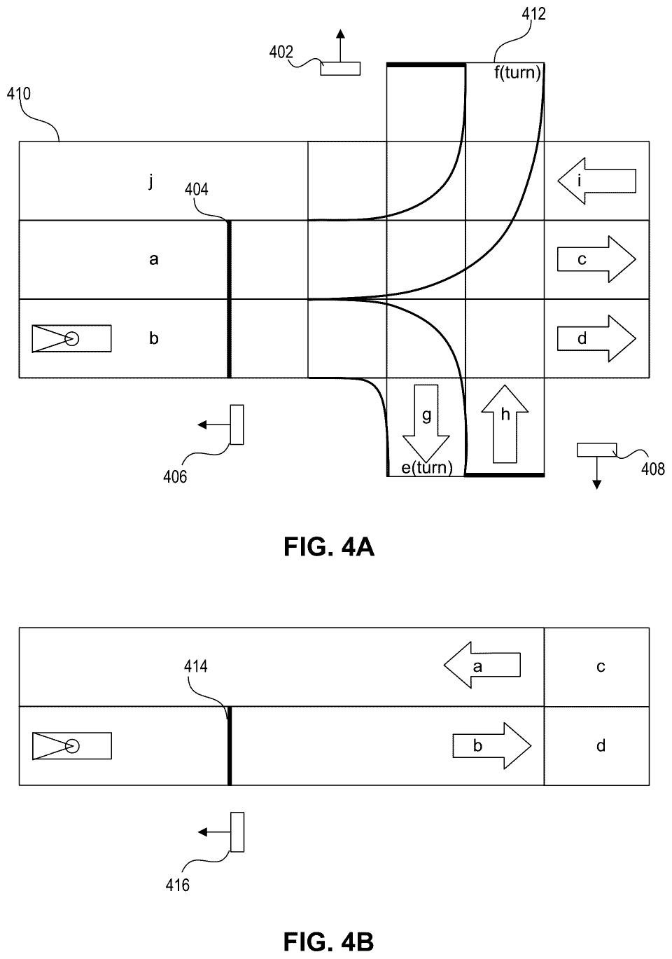

FIG. 4A is a schematic that illustrates a road intersection with an unmapped traffic sign, in accordance with aspects of the disclosure. A first road 410 intersects with a second road 412 in the road intersection. The first road 410 includes lane segments a, b, c, d, i, and j. Second road 412 includes lane segments g and h. Segment e represents the turn lane from segment b to segment g. Segment f represents the turn lane from segment a to segment h. FIG. 4A shows an unmapped stop sign 406 near an existing intersection (i.e., the intersection is included in the static vector map). Stop signs 402 and 408 are mapped stop signs (e.g., included in the static vector map 302). The arrows associated with the stop signs 406, 402, and 408 indicate the direction that each sign faces.

As discussed above, the nearest lane segment within a position and orientation tolerance may be found and associated with the unmapped stop sign. In FIG. 4A, lane segment b is the nearest lane segment associated with the unmapped stop sign 406. Note that even though lane segment g is near the unmapped stop sign 406, the unmapped stop sign 406 does not face the direction of travel of lane segment g. Thus, the unmapped stop sign 406 is not associated with lane segment g as the nearest lane segment. Lane segment a represents the same-direction neighboring lane to the segment b.

Lane segments c, d, e, and f are successors of lane segment a and lane segment b, respectively. The unmapped stop sign 406 is sufficiently near the successors. Thus, unmapped stop sign 406 is associated with the successors. According to some aspects of this disclosure, a stop sign is sufficiently near the successors if the successors are within a threshold distance from the stop sign. For example, the threshold distance may be less than 3 meters, 4 meters, 5 meters, or the like.

An inferred stop line 404 is placed at the physical location of the unmapped stop sign 406. The inferred stop line 404 is orthogonal to lane segments a and b. The conflict type lane conflicts between lane segments c, d, e, and f (to which the unmapped sign is associated) and the lane segments g, h, and i (of the cross street and opposing lane) are updated. The conflict type is changed from “yield to me” to “mutual yield” because the lane segments g, h, and i also have associated stop signs 402, 408, and 4XX respectively. If lane segments g, h, and i did not have associated stop signs, then the conflict type would be changed to “yield to them”, signifying that traffic in lane segments g, h, and i has right of way over traffic in lane segments in lane segment c, d, e, and f. According to some aspects of this disclosure, the inferred stop line may not correspond the endpoint of a lane segment. The inferred stop line may be located at a predetermined distance from the endpoint of the lane segment. For example, the inferred stop line may be located 0.5 meters before the endpoint of the lane segment.

FIG. 4B is a schematic that illustrates a road with an unmapped traffic sign, in accordance with aspects of the disclosure. FIG. 4B shows a single road that includes segments a, b, c, and d. Segments b and d have a first direction of travel and segments c and a have a second direction of travel (opposite to the first direction). An unmapped detected sign 416 is detected in the lane segment b. The unmapped detected sign 416 is not near a mapped intersection. The lane segment b is within a position and orientation tolerance of unmapped detected sign 402. There is no same-direction neighbor lane segment for the lane segment b. The successor of lane segment b is lane segment d. However, lane segment d is not sufficiently near the unmapped detected sign 416, thus the sign is not associated with lane segment d. For example, a start point of the lane segment d is located more than a threshold distance (e.g., more than 3 meters, more than 4 meters, more than 5 meters, or the like) from a physical location of unmapped detected sign 416.

An inferred stop line 414 is placed at the physical location of the unmapped detected sign 416. The inferred stop line 414 is orthogonal to lane segment b. In the example shown in FIG. 4, there is no lane conflicts to update.

According to some aspects of this disclosure, lane conflict type may be updated when a new unmapped traffic sign is detected. The AV may update the conflict type of lane conflicts for lane segments associated with the unmapped traffic sign. A lane conflict specifies the right-of-way relationship between two lane segments in the map, a reference lane segment and a conflicting lane segment, through a conflict type. The conflict types may indicate yielding relationships. Ordered by increasing restrictiveness, the conflict types are “yield to me”, “mutual yield”, and “yield to them.” For “yield to me” traffic the conflicting lane is expected to yield to traffic in the reference lane. For “mutual yield” who has right of way depends on who arrived first to the intersection. The “mutual yield” is commonly associated with 4-way stops. For “yield to them,” traffic, the reference lane must yield to traffic in the conflicting lane. Map updates can only make conflict type more restrictive. For example, if previously the conflict type was “yield to me”, it might be changed to “mutual yield” or “yield to them.”

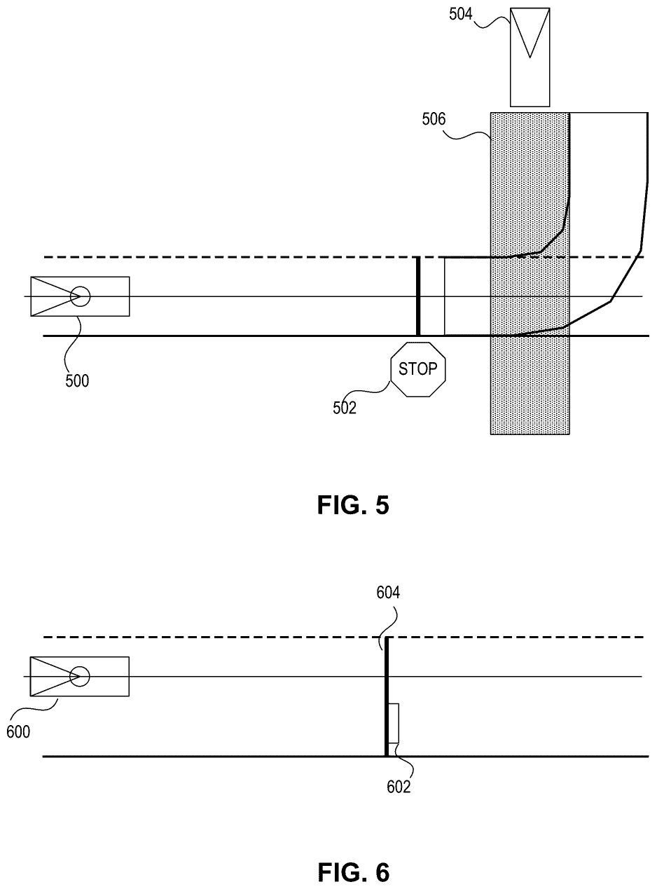

FIG. 5 is a schematic that illustrates a lane conflict type override, in accordance with aspects of the disclosure. FIG. 5 shows an AV 500 and a second AV 504. First AV 500 detects an unmapped stop sign 502 at an existing intersection. AV 504 may yield to other actors at the intersection. Thus, lane conflict for zone 506 is updated from yield to me conflict to mutual yield or yield to them. Lane conflicts in all lane segments may be updated. As discussed previously herein, the conflict type of all lanes can be updated only to be more restrictive (i.e., in the following order yield to me→mutual yield→yield to them). Lane conflict is generated for each lane segment that is flagged as in an intersection (i.e., they are associated with an intersection). The static and dynamic vector map may be checked to determine whether a lane segment is associated with the intersection. A separate interface may be provided to query for static and dynamic conflict type, so that existing map clients continue to access static conflict types as and/or if needed.

According to some aspects of this disclosure, the lane conflict type may be updated as follows. A first function may check whether the new conflict type is more restrictive than an original conflict type. For example, an existing conflict type may be retrieved by the map deviation task 312 and compared with a new conflict type. In response to determining that the new conflict type is more restrictive than the existing conflict type, a second function (e.g., an override function) may apply the new conflict type to the lane segment. According to some aspects of this disclosure, restrictions associated with a lane segment may be retrieved using a look-up table using a lane segment identifier.

FIG. 6 is a schematic that illustrates a stop line associated with an unmapped stop sign in a drivable area, in accordance with aspects of the disclosure. An unmapped stop sign 602 is located in the drivable area of an AV 600. AV 600 may treat the unmapped stop sign 602 as a static obstacle. The motion planning task 316 can avoid the unmapped stop sign 602 using the same method as another static obstacle. According to some aspects of this disclosure, the static object is not associated with the unmapped stop sign for the map updates. That is, the unmapped stop sign is not characterized as a static object in the dynamic vector map 304. According to some aspects of this disclosure, a stop line 604 is associated with the unmapped stop sign 602.

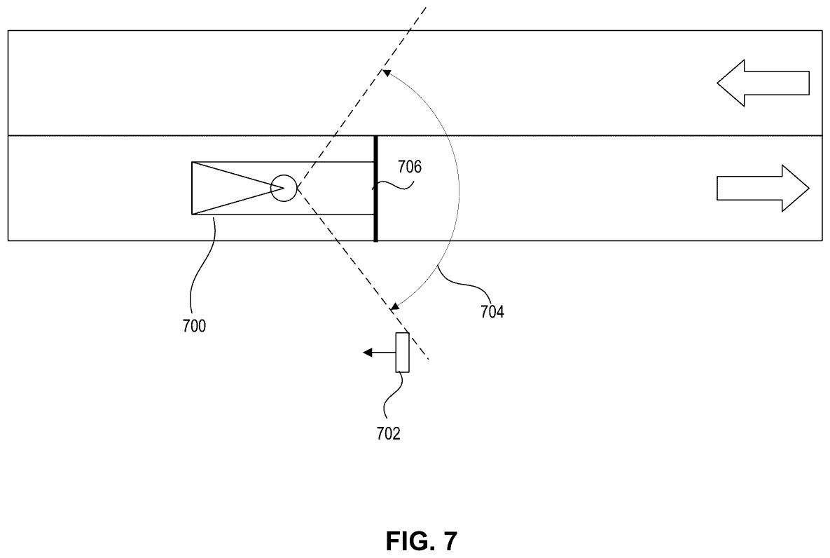

FIG. 7 is a schematic that illustrates a field of view of an AV, in accordance with aspects of the disclosure. Unmapped tracked signs and their associated map updates are retained even after the unmapped sign leaves the field of view of the AV's perception system such that the AV continues to react appropriately. For example, as shown in FIG. 7, a perception system of an AV 700 may no longer detect an unmapped sign 702 when the AV 700 is stopped along an inferred stop line 706 associated with the unmapped sign 702. The unmapped sign 702 is not within a field of view 704 of the AV 700. However, the map deviation for the unmapped sign 702 persists such that the AV 700 still stops at the inferred stop line 706.

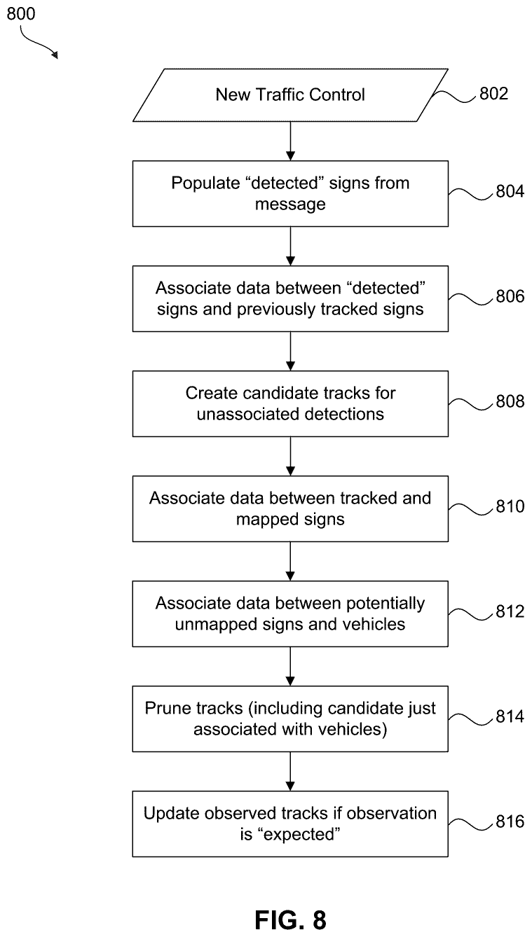

FIG. 8 is a flowchart for a method 800 for updating tracks, in accordance with aspects of the disclosure. Method 800 may be performed by the components and modules of system 300. For example, the on board computing device 113 and/or 220 can store instructions on a non-transitory computer-readable medium, and have one or more processors to execute the stored instructions to implement method 800. Moreover, the various components described in FIG. 2 can be used in conjunction with and/or to support the implementation of method 800. Method 800 can comprise a series of steps.

At 802, a new traffic control message may be generated. For example, a traffic sign may be detected by the detection task 306. The new traffic control message may include the position and orientation of the traffic sign.

At 804, attributes associated with detected signs may be populated from the message. According to some aspects of this disclosure, the system 300 may distinguish between tracks that are no longer relevant and tracks that are associated with false positive detections. For example, a time attribute associated with each track may indicate how long a track has gone without observation may be tracked. For example, the track may no longer be relevant to the AV when the sign is beyond a threshold distance (e.g., 20 m) of the AV and the track has not been updated with a new observation in a threshold period (e.g., 350 ms). Another attribute may indicate a probability of existence that may be associated with each track. The probability of existence may be tracked over time. For example, although the track may be disregarded if the probability of existence is below a threshold in a first instance, low confidence detections may build confidence over time (i.e., the probability of existence may increase). Thus, the track may not be disregarded in a second instance if the probability of existence is above the threshold.

At 806, data between a detected sign and previously tracked signs may be associated. For example, all detections may be matched with existing tracks. A cost function used to associate the detected sign with a previously tracked sign may be based on intersection over union (IOU) between the detection and a dilated track bounding box. In addition, the cost function may be modified based on the sign type so that if two signs are close together (on the same signpost for example), data associate attempt to assign detections in a way that is consistent with the observed tracked type.

At 808, a newly created track may be created for each unassociated detection. These new tracks may considered candidate tracks and may be immediately pruned if they are associated with a vehicle in a later step.

At 810, data between tracked signs and mapped signs are associated. Tracked signs include previously tracked signs and newly detected signs tracks. The cost function may be based on IOU between the track and a dilated map bounding box. The cost function may be further based on the object type (e.g., stop sign or yield sign). According to some aspects of this disclosure, if the tracked sign is likely the same type as a mapped sign with any non-zero overlap, the maximum cost is assigned.

At 812, data between potentially unmapped signs and a vehicle are associated. Only traffic signs that have a fixed location are tracked. For example, if the detected traffic sign is on a vehicle (e.g., a school bus), the detected traffic sign is not tracked.

At 814, one or more tracks are pruned. The pruned one or more tracks may include candidate tracks associated with vehicles (e.g., a stop sign on a vehicle or a construction truck).

At 816, observed tracks are updated in response to determining that the observation is expected. Attempting to accurately determine whether a detection is expected depends on sensor geometry, occlusion reasoning, and detection uncertainty. For example, factors that are used to estimate the “detectability” of a sign include whether there are no tracks between the AV and the center of the detected sign, whether the sign is unoccluded in the visibility grid, whether the AV is within a threshold radius (30 m) of the sign, whether the AV is on the same side of the sign as when it was originally observed (to make sure that the back of the sign is not detected), and whether the vector connecting the center of vehicle to the center of the sign is aligned with the normal vector of the sign (+/−25 degrees).

As described previously herein, a probability of existence for each track may be determined. The probability of existence may be represented as a variable that may be updated using a binary Bayes filter. Each time a new observation is fused with the track, the probability of existence increases. If a detection for a given track is not received when it is expected, that information is also fused into the binary Bayes filter.

To estimate a sign's probability of existence P(Et), the detector's probability of detection Pp; include the requirements listed above. The probability may be determined using a detectability estimator that receives a sign track and detector characteristic as inputs and outputs the probability. P_{Di} can be interpreted as the likelihood that the detector can detect a sign with the same attributes (position, attitude, etc.) as sign i. Bayes' rule may be used to update the sign's probability of existence:

$$P ( {E}_{i} \vert Z ) = η P ( Z \vert {E}_{i} ) * P ( {E}_{i} ) \qquad ( 1 )$$

where Z=1 if sign i is detected at time t, and Z=0 otherwise. η is the normalization coefficient which is equal to the inverse of P(Z) and can be calculated by marginalizing over Eᵢ:

$$P ( Z ) = P ( Z \vert {E}_{i} = 1 ) * P ( {E}_{i} = 1 ) + P ( Z \vert {E}_{i} = 0 ) * P ( {E}_{i} = 0 ) \qquad ( 2 )$$

Since Eᵢ is a binary variable, the following scenarios may be identified.

One detection is assigned to the tracked sign i, Z=1. The probability of existence P(Eᵢ=1) is updated as follows:

$$P ( {E}_{i} = 1 \vert Z = 1 ) = \frac{P ( Z = 1 \vert {E}_{i} = 1 ) * P ( {E}_{i} = 1 )}{P ( Z = 1 \vert {E}_{i} = 1 ) * P ( {E}_{i} = 1 ) + P ( Z = 1 \vert {E}_{i} = 0 ) * P ( {E}_{i} = 0 )} \qquad ( 3 )$$

where P(Z=1|Eᵢ=1) is equivalent to Pp; that is obtained from the detectability estimator. P(Z=1|Eᵢ=0) is the probability that is received a detection even though the sign doesn't exist. This is equivalent to the detector's probability of false positives P_{FP}.

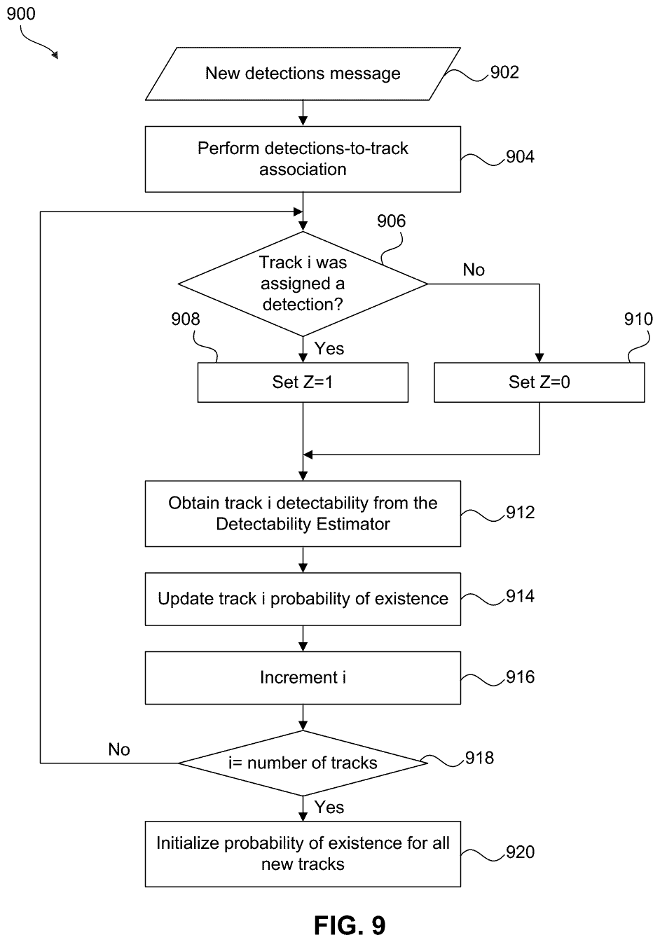

In a second example, the tracked sign i is not detected at time t, Z=0, P(Eᵢ=1) is updated as follows:

$$P ( {E}_{i} = 1 \vert Z = 0 ) = \frac{P ( Z = 0 \vert {E}_{i} = 1 ) * P ( {E}_{i} = 1 )}{P ( Z = 0 \vert {E}_{i} = 1 ) * P ( {E}_{i} = 1 ) + P ( Z = 0 \vert {E}_{i} = 0 ) * P ( {E}_{i} = 0 )} \qquad ( 4 )$$

where P(Z=0|Eᵢ=1)=1−P_{D}_{ᵢ} is the probability of miss-detecting an existing sign and P(Z=0|Eᵢ=0) is the probability of a true negative and is equivalent to 1−P_{FP}. FIG. 9 is a flowchart for a method for handling a detected traffic sign, in accordance with aspects of the disclosure.

At 902, a new detection message may be received. For example, the detection task 306 may send a message to the map deviation task 312.

At 904, detections and tracks association may be performed as described in relation to FIG. 8. A counter may be initialized. For example, a value of the counter may be set to zero.

At 906, a determination is made to whether the track is assigned to a detection. In response to determining that the track is not assigned to a detection (resulting in a “No”), the process proceeds to 910. In response to determining that the track is assigned to a detection, the process proceeds to 908. At 910, Z is set to zero. At 908, Z is set to one.

At 912, the detectability of track i may be determined. For example, the detectability may be determined by a detectability estimator based on the factors described above and as discussed further below.

At 914, the probability of existence of track i is updated using equations (3) and (4).

At 916, the counter is updated. For example, the counter may be incremented by one.

At 918, a determination is made whether the value of the counter is equal to the number of tracks. In response to determining that the value of the counter is equal to the number of tracks, the process proceeds to 920. In response to determining that the value of the counter is not equal to the number of tracks, the process proceeds to 906. At 920, the probability of existence is initialized for all new tracks.

As previously discussed, the probability of existence of a sign depends on the detectability of the sign. The detectability of the sign may be dependent on the characteristics of the detectors and complex interactions between dynamic objects in the scene. The interactions may lead to the traffic sign being partially or fully occluded. These occlusions might be short-term or long-term, rendering signs invisible to the detection system (e.g., detection task 306 of FIG. 3) for several seconds, and burdening the tracker with the task of reasoning about whether the sign is occluded or the track is a false positive.

The occlusion of the sign may be determined using a visibility grid to estimate how likely a sign is visible to the perception system. Using the sign's 2D coordinates in the map frame {x, y}, the visibility grid may be queried for the state of the cell where the sign is located. Table 1. Summarizes the different possible outcomes.

TABLE 1
Occlusion results

| Cell Status | Physical Interpretation | P(vᵢ)_{VG} |
|---|---|---|
| Occupied (max height Hₘₐₓ) | The cell contains an object which could be the sign itself or anything else (in case of a false positive sign) or a true positive sign that is placed higher than Th_{VG} alongside another object in the cell. | ${P ( {v}_{i} )}_{VG} = \{ \begin{matrix}α & sign height > {Th}_{VG} \\ β & sign height < {H}_{max} \\ γ & {H}_{max} < sign height < {Th}_{VG}\end{matrix}$ 1 > β > α > γ > 0 |
| Occluded (occlusion | The cell is occluded and the sign can't be visible if it's below the occlusion height | ${P ( {v}_{i} )}_{VG} = \{ \begin{matrix}γ & signheight < {H}_{occlusion} \\ α & otherwise\end{matrix} \}$ |
| height | | |
| H_{occlusion}) | | |

P(vᵢ)_{VG} can be used to reason about signs' visibility. However, the visibility grid may suffer from shortcomings that leak some ambiguity into P(vᵢ)_{VG}. The visibility grid may ignore LIDAR points higher than Th_{VG}=1.8 m. However, most signs are placed at least 1.8 m above the pavement level. If a cell is occluded, the occlusion state is set to the minimum occlusion height and assumes everything above is visible which is often not the case.

In order to resolve the ambiguity in P(vᵢ)_{VG}, a complementary occlusion reasoning logic may be provided. For every track with a valid cuboid (e.g., a 3-dimensional bounding box) in the detection message (e.g., generated by the detection task 306). The cuboid is predicted to the current time of validity (ToV) and the predicted cuboid is projected to an image space of the camera where the sign is detected. The camera is identified by a unique identifier (ID).

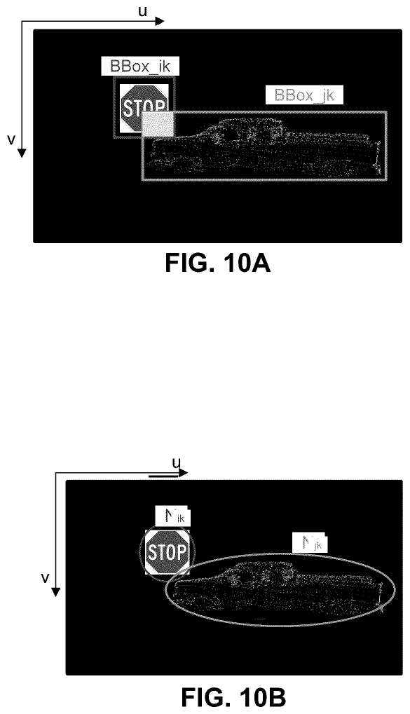

The 2D bounding box that encapsulates the cuboid's projected points in image space BBoxⱼₖ where j is the track index and k is the camera ID is found as shown in FIG. 10A. The image bounding box of the traffic sign BBoxᵢₖ is obtained. For every track j, the area of intersection between its image bounding box and the sign's divided by the area of the signBBoxᵢₖ is found. The area may be expressed as:

$${O}_{ij} = intersection area ( {BBox}_{jk} , {BBox}_{ik} ) / area ( {BBox}_{ik} ) \qquad ( 5 )$$

Assuming that the same area of the sign cannot be occluded by more than one track j, the total occlusion area of the sign is determined as follows:

$${P ( {v}_{i} )}_{ImagePoints} = 1 - {\sum }_{j} {O}_{ij} \qquad ( 6 )$$

In case several track boxes intersect with the sign box BBoxᵢₖ, Σⱼ Oᵢⱼ might add up to more than one if the track boxes themselves intersect with each other. To handle this the common intersection area between the tracks and the sign is found and subtracted.

In case a sign is detected by multiple cameras, the same procedure for every camera k is repeated. The sign's visibility to the maximum value obtained from any single camera is set to:

$${P ( {v}_{i} )}_{ImagePoints} = max ( {P ( {v}_{i} )}_{ImagePoints 1} , {P ( {v}_{i} )}_{ImagePoints 2} , … , {P ( {v}_{i} )}_{ImagePointsk} ) .$$

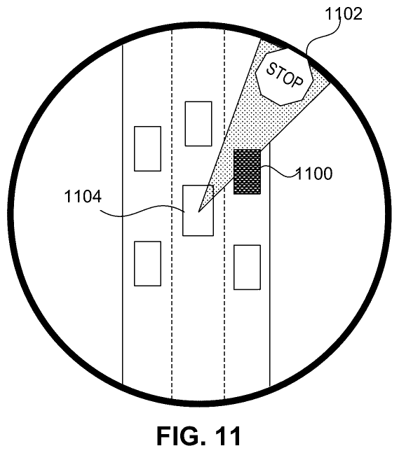

According to some aspects of this disclosure, the preceding steps may not be repeated for all vehicle tracks if the vehicle cannot possibly occlude the sign. For example, P(vᵢ)_{ImagePoints} can be evaluated using only the tracks whose bounding boxes intersect with a frustum centered on the sensor frame and encloses the sign's bounding box as shown in FIG. 11.

FIG. 11 is a schematic that illustrates relevant tracks in evaluating the total occlusion area, in accordance with aspects of the disclosure. Vehicle track 1100 is used in evaluating P(vᵢ)_{ImagePoints} for detection of a traffic sign 1102 by an AV 1104.

Other than occlusion, a sign is only detectable if the face of the sign is visible to the detection task 306 (e.g., camera). To account for this, another term P(vᵢ)_{SignFace} is added to the detectability determination that models the probability the sign's face is visible. P(vᵢ)_{SignFace} depends on the azimuth angle between the sign's surface normal, and the vector connecting the AV and the center of the sign θᵢ. For example, the cosine of θᵢ is used to model sign face visibility P(vᵢ)_{SignFace}=max(cos(θᵢ), 0), or simply use some threshold on θᵢ:

$${P ( {v}_{i} )}_{SignFace} = \{ \begin{matrix}h & if \vert {θ}_{i} \vert < {Th}_{angle} \\ l & otherwise\end{matrix} \} \qquad ( 7 )$$

$$where 1 > h > l > 0.$$

The sign's visibility is the joint probability of all three components (assuming independence):

$$P ( {v}_{i} ) = {P ( {v}_{i} )}_{SignFace} * {P ( {v}_{i} )}_{VG} * {P ( {v}_{i} )}_{ImagePoints} \qquad ( 8 )$$

Then, the total detectability of sign i can be modeled as:

$${P}_{Di} = P ( detect , visible ) = P ( detect \vert {v}_{i} ) * P ( {v}_{i} ) \qquad ( 9 )$$

where P(detect|vᵢ) is the probability the detector will detect a visible sign which is a function of both the detector's internal characteristics, and the distance dᵢ between the sign and the sensor. For example, P(detect|vᵢ) can be inversely proportional to dᵢ as follows (assuming the detector can't pick up any detections further than 30 meters away):

$$P ( detect \vert {v}_{i} ) = max ( 0 , 1 - \frac{{d}_{i}}{30} ) \qquad ( 10 )$$

According to some aspects of this disclosure, the sign detectability may be determined as follows. The surface model to the image space of the camera where the sign was detected is projected for each track. Thus, a list of 2D points that represent the visible surface of the track from the camera's perspective is obtained. The list of the 2D points may be referred to as ImagePointsⱼₖ={[u₀, v₀], [u₁, v₁], . . . , [uₙ, vₙ]} where j is the index of the track in the feedback message and k is the ID of the camera that detected the sign. [u, v] are the pixel coordinates of the projected surface model points.

A 2D Gaussian is fitted to represent the area of ImagePointsⱼₖ. The area may be referred to as Nⱼₖ=N([u, v]^{T}, cⱼ, Cⱼ). A 2D Gaussian representing the area of sign i in the image space is obtained as shown in FIG. 10B. The 2D Gaussian representing the area may be referred to as Nᵢₖ=N([u, v], cᵢ, Cᵢ).

For every track j, the intersection area of the track j with the sign i is calculated as follows:

$$\begin{matrix}{z}_{j} = \int {N}_{ik} * {N}_{jk} d ( {[ u , v ]}^{T} ) & ( 11 ) \\ {z}_{ij} ∼ N ( {c}_{i} ; {c}_{j} , {C}_{ij} ) & ( 12 ) \\ {C}_{ij} = {C}_{i} + {C}_{j} & ( 13 )\end{matrix}$$

The relative overlap between track j and sign i is obtained using the unnormalized Gaussian:

$$\begin{matrix}{V}_{ij} = exp ( - 0.5 [ {c}_{i} - {c}_{j} {[}^{T} {C}_{ij}^{- 1} [ {c}_{i} - {c}_{j} ] ) & ( 14 ) \\ {V}_{ij} = 1 if {c}_{i} = {c}_{j} & ( 15 )\end{matrix}$$

Assuming that the sign cannot be occluded by more than one track j, the total occlusion area of the sign as follows:

$${P ( {v}_{i} )}_{ImagePoints} = {\sum }_{j} {V}_{ij} \qquad ( 16 )$$

### Probability of Mapped/Unmapped

According to some aspects of this disclosure, the mapped/unmapped decision is made solely based on whether the track is associated with a mapped sign or not in a current update cycle. This hard decision rule can lead to frequent switching of the tracks mapped\unmapped status for the same sign if the detections are noisy. According to some aspects of this disclosure, the property may be smoothed by evaluating and updating an estimate of the probability of a mapped\unmapped sign.

The probability of track i being mapped may be referred to as P(Mᵢ), and log-odds binary Bayes filter may be used to update P(Mᵢ).

$${l}_{t} = {l}_{t - 1} + log ( \frac{P ( {M}_{i} \vert {Z}_{m} )}{1 - P ( {M}_{i} \vert {Z}_{m} )} ) \qquad ( 17 )$$

where the initial value l₀ is given as:

$${l}_{0} = log ( \frac{P ( {M}_{i} )}{1 - P ( {M}_{i} )} ) \qquad ( 18 )$$

where Zₘ is the set of mapped signs assigned to track i at time t. It can be empty Z_{M}={ϕ} or contains at most one mapped sign Z_{M}={zₘ_{ⱼ}}. P(Mᵢ|Zₘ) is the reverse likelihood function of sign i being mapped given the set of associated mapped sign Z_{M}.

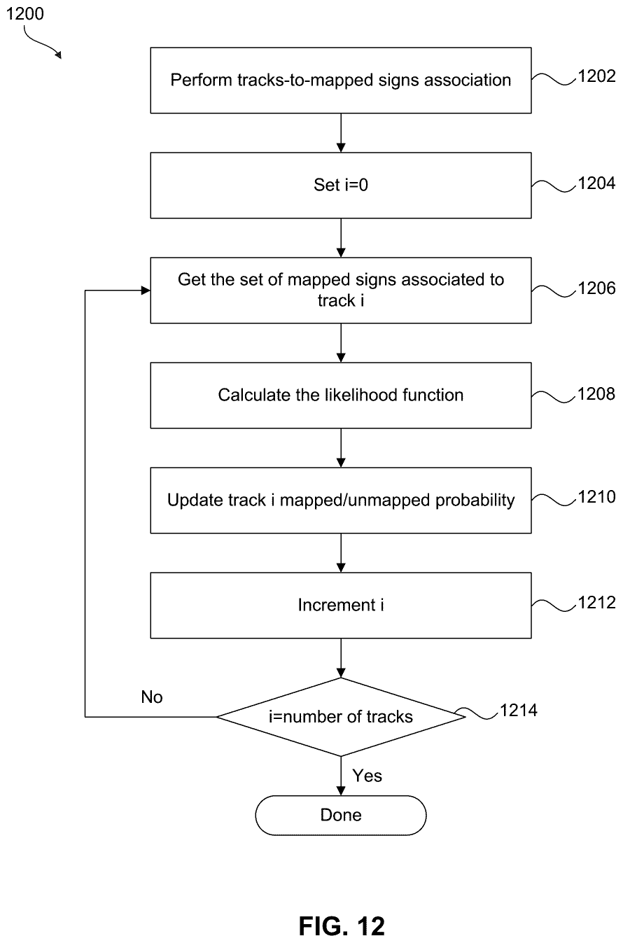

FIG. 12 is a flowchart for a method 1200 for updating a probability of a mapped sign, in accordance with aspects of the disclosure.

At 1202, tracks to mapped signs association is performed as described above.

At 1204, a counter is initialized. For example, a value of the counter is set to zero.

At 1206, the set of mapped signs associated with a track are identified.

At 1208, the likelihood function is determined. For example, the likelihood may be determined from and/or based on equation (17) and/or the like.

At 1210, a probability of mapped/unmapped is updated as described above.

At 1212, the value of the counter is updated. For example, the value of the counter may be incremented (e.g., by one).

At 1214, a determination is made as to whether the value of the counter is equal to the number of tracks. In response to determining that the value of the counter is not equal to the number of tracks, the process proceeds to step 1206. In response to determining that the counter value is equal to the number of tracks, the process ends.

A visualization plugin is added to a tracking visualizer. According to some aspects of this disclosure, the visualization plugin may be used to obtain a list of current sign tracks IDs and their metadata. A table of the latest detections-to-tracks assignment decisions and their corresponding costs may be displayed. A table of the latest tracks-to-mapped assignment decisions and their corresponding costs may also be displayed. A track by ID may be selected to display more metadata. The evolution of probability of existence P(Et) for the currently selected track alongside its detectability history PD; may be plotted. A histogram of the selected track type, and, optionally, the history of the sign type updates may be displayed.

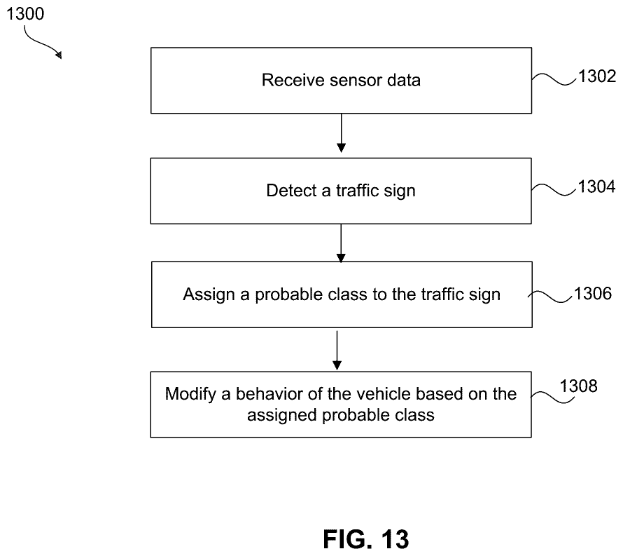

FIG. 13 is a flowchart for a method 1300 for handling traffic signs, in accordance with aspects of the disclosure.

At 1302, sensor data are received from a sensor of a vehicle.

At 1304, a traffic sign is detected within a field of view of the vehicle based on the sensor data.

At 1306, a probable class is assigned to the detected sign based on a determination that the detected sign is not mapped in a priori map and a determination that a probability of existence of the sign is greater than a threshold. According to some aspects of this disclosure, the probability of the type of the detected sign is determined. The type of the traffic sign may be a stop sign or a yield sign. In addition, a position and orientation of the detected sign may be determined based on the sensor data.

At 1308, a behavior of the vehicle is adjusted based on the assigned probable class. According to some aspects of this disclosure, a map update may be performed. For example, the map update may comprise a type of the detected sign, one or more lane segments associated with the detected sign, a stop line associated with the detected sign, and one or more legal requirements for the one or more lane segments associated with the detected sign (e.g., lane conflict update).

It has been discovered that the system 300 described above significantly improves the state of the art from conventional systems in that it provides a unique architecture that can be used to handle unmapped traffic signs. The benefit of the system over conventional systems is that it provides updates to all modules of the AV and other AVs in a timely manner which reduces the risk that an AV misses a traffic sign (e.g., a stop sign) because it is not reflected in the map. In addition, all tasks of the AV receive the same update thus the trajectory generated is accurate and based on an updated map.

Various examples, aspects, and/or embodiments can be implemented, for example, using one or more computer systems, such as computer system 1400 shown in FIG. 14. Computer system 1400 can be any computer capable of performing the functions described herein.

Computer system 1400 includes one or more processors (also called central processing units, or CPUs), such as a processor 1404. Processor 1404 is connected to a communication infrastructure or bus 1406.

One or more processors 1404 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1400 also includes user input/output device(s) 1403, such as monitors, keyboards, pointing devices, etc., that communicate with communication infrastructure 1406 through user input/output interface(s) 1402.

Computer system 1400 also includes a main or primary memory 1408, such as random access memory (RAM). Main memory 1408 may include one or more levels of cache. Main memory 1408 has stored therein control logic (i.e., computer software) and/or data.

Computer system 1400 may also include one or more secondary storage devices or memory 1410. Secondary memory 1410 may include, for example, a hard disk drive 1412 and/or a removable storage device or drive 1414. Removable storage drive 1414 may be a floppy disk drive, a magnetic tape drive, a compact disk drive, an optical storage device, tape backup device, and/or any other storage device/drive.

Removable storage drive 1414 may interact with a removable storage unit 1418. Removable storage unit 1418 includes a computer usable or readable storage device having stored thereon computer software (control logic) and/or data. Removable storage unit 1418 may be a floppy disk, magnetic tape, compact disk, DVD, optical storage disk, and/any other computer data storage device. Removable storage drive 1414 reads from and/or writes to removable storage unit 1418 in a well-known manner.

According to an exemplary embodiment, secondary memory 1410 may include other means, instrumentalities or other approaches for allowing computer programs and/or other instructions and/or data to be accessed by computer system 1400. Such means, instrumentalities or other approaches may include, for example, a removable storage unit 1422 and an interface 1420. Examples of the removable storage unit 1422 and the interface 1420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1400 may further include a communication or network interface 1424. Communication interface 1424 enables computer system 1400 to communicate and interact with any combination of remote devices, remote networks, remote entities, etc. (individually and collectively referenced by reference number 1428). For example, communication interface 1424 may allow computer system 1400 to communicate with remote devices 1428 over communications path 1426, which may be wired and/or wireless, and which may include any combination of LANs, WANs, the Internet, etc. Control logic and/or data may be transmitted to and from computer system 1400 via communication path 1426.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 1400, main memory 1408, secondary memory 1410, and removable storage units 1418 and 1422, as well as tangible articles of manufacture embodying any combination of the foregoing. Such control logic, when executed by one or more data processing devices (such as computer system 1400), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 14. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method, comprising:
receiving sensor data from a sensor of a vehicle;
identifying, using one or more computer devices, a traffic sign within a field of view of the vehicle based on the sensor data;
assigning, using the one or more computer devices, a probable class to the identified sign based on a determination that the identified sign is not mapped in a priori map and a determination that a probability of existence of the sign is greater than a threshold; and
modifying, by the one or more computer devices, a behavior of the vehicle based on the assigned probable class.

2. The method of claim 1, wherein assigning the probable class further comprises:
identifying a probability of a type of the identified sign, wherein the type is at least one of a stop sign or a yield sign; and
identifying a position and orientation of the identified sign.

3. The method of claim 1, further comprising:
comparing data associated with the identified sign with a record of false positive detections; and
disregarding the identified sign based on a determination that the identified sign is a false positive.

4. The method of claim 1, wherein modifying the behavior of the vehicle comprises:
performing a map update, wherein the map update comprises a type of the identified sign, one or more lane segments associated with the identified sign, a stop line associated with the identified sign, and one or more legal requirements for the one or more lane segments associated with the identified sign.

5. The method of claim 4, further comprising:
identifying a proximate lane segment within a position and orientation threshold of the identified sign;
identifying a neighbor segment of the proximate lane segment and a successor of the neighbor segment, wherein the neighbor segment has a same travel direction as the proximate lane segment; and
associating the identified sign with the neighbor segment of the proximate lane and with the successor when the successor satisfies at least a distance criterion.

6. The method of claim 4, further comprising:
propagating the map update to one or more vehicles.

7. The method of claim 1, wherein modifying the behavior of the vehicle comprises:
transmitting to a remote guidance operator information associated with the identified sign;
receiving from the remote guidance operator a first indication whether the identified sign is valid; and
receiving from the remote guidance operator a second indication to proceed after the vehicle autonomously determines it is appropriate to proceed.

8. The method of claim 7, further comprising:
performing a timed stop when a type of the identified sign is a stop sign; and
proceeding, after receiving the second indication to proceed, in response to determining that the path of the vehicle is clear of other road users.

9. The method of claim 1, wherein modifying the behavior of the vehicle comprises:
predicting an action of an actor that is proximate to the vehicle based on the identified sign; and
adjusting a vehicle trajectory for the vehicle based on the predicted action and the identified sign.

10. The method of claim 1, further comprising:
logging an annotation for the identified sign when the identified sign is an unmapped sign; and
updating the a priori map based on a determination that the unmapped sign is a permanent traffic sign.

11. The method of claim 1, further comprising:
determining whether the traffic sign is mapped by comparing the identified sign to signs in the a priori map, wherein the identified sign is mapped when a type of the identified sign matches a type of the mapped sign in the a priori map and is within a position and orientation tolerance of the mapped sign.

12. The method of claim 1, further comprising:
updating a record of false positive detections in response to determining that the identified sign is a false positive detection.

13. A system, comprising:
a memory; and
at least one processor coupled to the memory and configured to:
receive sensor data from a sensor of a vehicle;
identify a traffic sign within a field of view of the vehicle based on the sensor data;
assign a probable class to the identified sign based on a determination that the identified sign is not mapped in a priori map and a determination that a probability of existence of the sign is greater than a threshold; and
modify a behavior of the vehicle based on the assigned probable class.

14. The system of claim 13, wherein the at least one processor is further configured to:
identify a probability of a type of the identified sign, wherein the type is at least one of a stop sign or a yield sign; and
identify a position and orientation of the identified sign.

15. The system of claim 13, wherein the at least one processor is further configured to:
compare data associated with the identified sign with a record of false positive detections; and
disregard the identified sign based on a determination that the identified sign is a false positive.

16. The system of claim 13, wherein the at least one processor is further configured to:
perform a map update, wherein the map update comprises a type of the identified sign, one or more lane segments associated with the identified sign, a stop line associated with the identified sign, and one or more legal requirements for the one or more lane segments associated with the identified sign.

17. The system of claim 16, wherein the at least one processor is further configured to:
identify a proximate lane segment within a position and orientation threshold of the identified sign;
identify a neighbor segment of the proximate lane segment and a successor of the neighbor segment, wherein the neighbor segment has a same travel direction as the proximate lane segment; and
associate the identified sign with the neighbor segment of the proximate lane and with the successor when the successor satisfies at least a distance criterion.

18. A non-transitory computer-readable medium having instructions stored thereon that, when executed by at least one computing device, cause the at least one computing device to perform operations comprising:
receiving sensor data from a sensor of a vehicle;
detecting a traffic sign within a field of view of the vehicle based on the sensor data;
assigning a probable class to the identified sign based on a determination that the identified sign is not mapped in a priori map and a determination that a probability of existence of the sign is greater than a threshold; and
modifying a behavior of the vehicle based on the assigned probable class.

19. The non-transitory computer-readable medium of claim 18, the operations further comprising:
performing a map update, wherein the map update comprises a type of the identified sign, one or more lane segments associated with the identified sign, a stop line associated with the identified sign, and one or more legal requirements for the one or more lane segments associated with the identified sign.

20. The non-transitory computer-readable medium of claim 19, the operations further comprising:
identifying a proximate lane segment within a position and orientation threshold of the identified sign;
identifying a neighbor segment of the proximate lane segment and a successor of the neighbor segment, wherein the neighbor segment has a same travel direction as the proximate lane segment; and
associating the identified sign with the neighbor segment of the proximate lane and with the successor when the successor satisfies at least a distance criterion.
